(19) United States
(12) Patent Application Publication
(10) Pub. No.: US 2007/0070929 A1
(43) Pub. Date: Mar. 29, 2007

(54) Apparatus and method for negotiating relay station capability in a multi-hop relay broadband wireless access communication system

(75) Inventors: Hyun-Jeong Kang, Seoul (KR); Pan-Yuh Joo, Seoul (KR); Jung-Je Son, Seongnam-si (KR); Jae-Weon Cho, Suwon-si (KR); Hyoung-Kyu Lim, Seoul (KR); Yeong-Moon Son, Anyang-si (KR); Sung-Jin Lee, Seoul (KR); Mi-Hyun Lee, Seoul (KR); Song-Nam Hong, Seoul (KR); Young-Ho Kim, Suwon-si (KR)

Correspondence Address: DILWORTH & BARRESE, LLP, 333 EARLE OVINGTON BLVD., SUITE 702, UNIONDALE, NY, 11553, US

(73) Assignee: Samsung Electronics Co., Ltd., Suwon-si (KR)

(21) Appl. No.: 11/523,289

(22) Filed: Sep. 19, 2006

(30) Foreign Application Priority Data
Sep. 28, 2005 (KR) 2005-0090701
Nov. 1, 2005 (KR) 2005-0103630

(51) Int. Cl. H04B 7/00

(52) U.S. Cl. 370/310

(57) ABSTRACT

An apparatus and method for negotiating RS capability in a multi-hop relay cellular communication system are provided. In the RS capability negotiating method, a node configures a first message including first relay capability information indicating if the node supports an RS capability and sends the first message to a BS. The BS determines whether to select the node as an RS according to the first message, configures a second message including second relay capability information indicating if the node is selected as the RS according to the determination, and sends the second message to the node by the BS. The node operates as an RS or as a general node according to the second relay capability information of the second message.

### PRIORITY

This application claims priority under 35 U.S.C. § 119 to an application filed in the Korean Intellectual Property Office on Sep. 28, 2005 and assigned Serial No. 2005-90701, and an application filed in the Korean Intellectual Property Office on Nov. 1, 2005 and assigned Serial No. 2005-103630, the contents of which are incorporated herein by reference.

### BACKGROUND OF THE INVENTION

1. Field of the Invention

The present invention relates generally to a multi-hop relay Broadband Wireless Access (BWA) communication system and, in particular, to an apparatus and method for negotiating Relay Station (RS) capability.

2. Description of the Related Art

The provisioning of services with diverse Quality of Service (QoS) levels provided at about 100Mbps to users is an area experiencing extensive research for a future-generation communication system referred to as a 4^{th} Generation (4G) communication system. Particularly, extensive research is being conducted to provision high-speed services by ensuring mobility and QoS to a BWA communication system such as Wireless Local Area Network (WLAN) and Wireless Metropolitan Area Network (WMAN). Such major examples of these high-speed services are defined in the Institute of Electrical and Electronics Engineers (IEEE) 802.16a and IEEE 802.16e standards.

The IEEE 802.16a and IEEE 802.16e based communication systems are implemented by applying Orthogonal Frequency Division Multiplexing (OFDM)/Orthogonal Frequency Division Multiple Access (OFDMA) to physical channels of the WMAN system. IEEE 802.16a standard considers only a single-cell structure with no regard to the mobility of Subscriber Stations (SS). In contrast, IEEE 802.16e standard supports the mobility of a SS to the IEEE 802.16a communication system. A mobile SS is also referred to as a mobile station (MS).

FIG. 1 illustrates the configuration of the typical IEEE 802.16e communication system.

Referring to FIG. 1, the IEEE 802.16e communication system is configured in a multi-cell structure. Specifically, the IEEE 802.16e communication system is comprised of cells 100 and 150, BSs 110 and 140 for managing the cells 100 and 150, respectively, and a plurality of MSs 111, 113, 130, 151 and 153. Signals are sent in OFDM/OFDMA format between the BSs 110 and 140 and the MSs 111, 113, 130, 151 and 153. The MS 130 exists in a cell boundary area between the cells 100 and 150, i.e. in a handover region. When the MS 130 moves to the cell 150 managed by the BS 140 during signal transmission/reception to/from the BS 110, the serving BS of the MS 130 is changed from the BS 110 to the BS 140.

Since signaling is carried out between an MS and a fixed BS via a direct link as illustrated in FIG. 1, a highly reliable radio communication link can be established between the MS and the BS in the typical IEEE 802.16e communication system. However, due to the fixedness of BSs, a wireless network cannot be configured with flexibility. As a result, the IEEE 802.16e communication system is not effective in efficiently providing communication services under a radio environment experiencing a fluctuating traffic distribution and a great change in the number of required calls.

These problems may be solved by applying a multi-hop relay data transmission scheme using fixed RSs, mobile RSs, or general MSs to general cellular wireless communication systems such as IEEE 802.16e. The multi-hop relay wireless communication system can reconfigure a network rapidly according to environmental changes and enables efficient operation of the entire wireless network. For example, the multi-hop relay wireless communication system can expand cell coverage and increase system capacity. When the channel status between a BS and an MS is bad, an RS can be installed between them so that the resulting establishment of a multi-hop relay through the RS renders an excelled radio channel available to the MS. With the use of the multi-hop relay scheme at a cell boundary placed in a bad channel status, high-speed data channels are available and the cell coverage is expanded.

FIG. 2 illustrates the configuration of a multi-hop relay BWA communication system configured to expand the coverage of BSs.

Referring to FIG. 2, the multi-hop relay BWA communication system, which is configured in a multi-cell structure, includes cells 200 and 240, BSs 210 and 250 for managing the cells 200 and 240, respectively, a plurality of MSs 211 and 213 within the coverage area of the cell 200, a plurality of MSs 221 and 223 managed by the BS 210 but located outside the coverage area 230 of the cell 200, an RS 220 for providing multi-hop relay paths between the BS 210 and the MSs 221 and 223 within the coverage area 230, a plurality of MSs 251, 253 and 255 within the coverage area of the cell 240, a plurality of MSs 261 and 263 managed by the BS 250 but located in the coverage area 270 of an RS 260 outside the coverage area of the cell 240, and the RS 260 for providing multi-hop relay paths between the BS 250 and the MSs 261 and 263 within its coverage area 270. Signals are transmitted among the BSs 210 and 250, the RSs 220 and 260, and the MSs 211, 213, 221, 223, 251, 253, 255,261 and 263 in OFDM/OFDMA.

Although the MSs 211 and 213 within the coverage area of the cell 200 and the RS 220 can communicate directly with the BS 210, the MSs 221 and 223 within the area 230 cannot directly communicate with the BS 210. Therefore, the RS 220 covering the area 230 relays signals between the BS 210 and the MSs 211 and 223. Although the MSs 251, 253 and 255 within the coverage area of the cell 240, and the RS 260 can communicate directly with the BS 250, the MSs 261 and 263 within the area 270 cannot directly communicate with the BS 250. The RS 260 having the coverage area 270 under its control relays signals between the BS 250 and the MSs 261 and 263.

FIG. 3 illustrates the configuration of a multi-hop relay BWA communication system configured to increase system capacity.

Referring to FIG. 3, the multi-hop relay wireless communication system includes a BS 310, a plurality of MSs 311, 313, 321, 323, 331 and 333, and RSs 320 and 330 for providing multi-hop relay paths between the BS 310 and the MSs. Signaling is carried out in OFDM/OFDMA among the BS 310, the RSs 320 and 330 and the MSs 311, 313, 321, 323, 331 and 333. The BS 310 manages a cell 300, and the MSs 311, 313, 321, 323, 331 and 333 within the coverage area of the cell 300 and the RSs 320 and 330 can communicate directly with the BS 310.

Yet, the direct links between the BS 310 and the MSs. 321, 323, 331 and 333 close to the boundary of the cell 300 may have low Signal-to-Noise Ratios (SNRs). The RS 320 relays unicast traffic between the BS 310 and the MSs 321 and 323, while the RS 330 relays unicast traffic between the BS 310 and the MSs 331 and 333. The RSs 320 and 330 provide high-speed data transmission paths to the MSs 321, 323, 331 and 333, thereby increasing the effective data rates of the MSs and the system capacity.

In the multi-hop relay BWA communication systems illustrated in FIGS. 2 and 3, the RSs 220, 260, 320 and 330 are infrastructure RSs installed and managed by the BSs 210, 250 and 310, or SSs or MSs which can serve as client RSs. The RSs 220, 260, 320 and 330 may also be fixed, nomadic (e.g. laptop), or mobile like MSs.

In the above-described multi-hop relay BWA communication system, a BS selects a potential RS as an RS for relaying between an MS and the BS in order to increase system capacity or expanding the coverage of the BS. Accordingly, there exists a need for defining a method and procedure for enabling the BS to recognize a potential RS and negotiating RS capability support with the potential RS during an initial connection procedure with the potential RS in the multi-hop relay BWA communication system.

### SUMMARY OF THE INVENTION

An aspect of the present invention is to substantially solve at least the above problems and/or disadvantages and to provide at least the advantages below. Accordingly, an aspect of the present invention is to provide an apparatus and method for notifying whether a node supports an RS capability during an initial connection procedure in a multi-hop relay BWA communication system.

Another aspect of the present invention is to provide an apparatus and method for recognizing a potential RS and negotiating RS capability support with a potential RS during an initial connection procedure in a BS in a multi-hop relay BWA communication system.

The above aspects are achieved by providing an apparatus and method for negotiating RS capability in a multi-hop relay cellular communication system.

According to one aspect of the present invention, in a method of negotiating RS capability in a multi-hop relay cellular communication system, a node configures a first message including first relay capability information indicating if the node supports an RS capability and sends the first message to a BS. The BS determines whether to select the node as an RS according to the first message, configures a second message including second relay capability information indicating if the node is selected as the RS according to the determination, and sends the second message to the node by the BS. The node operates as an RS or as a general node according to the second relay capability information of the second message.

According to another aspect of the present invention, in a method of negotiating RS capability in a multi-hop relay cellular communication system, a node configures a first message including first relay capability information indicating if the node supports an RS capability and sends the first message to an upper-layer RS. The upper-layer RS determines if the node supports an RS capability, upon receipt of the first message, configures a second message including the first relay capability information and an ID of the node, and sends the second message to a BS. The BS determines whether to select the node as an RS according to the second message, configures a third message including second relay capability information indicating if the node is selected as the RS and the ID of the node according to the determination, and sends the third message to the upper-layer RS. Upon receipt of the third message, the upper-layer RS configures a fourth message including the second relay capability information and sends the fourth message to the node. The node operates as an RS or as a general node according to the second relay capability information of the fourth message.

According to a further aspect of the present invention, in an apparatus for negotiating RS capability in a multi-hop relay cellular communication system, a node configures a first message including first relay capability information indicating if a node supports an RS capability, sends the first message to a BS, receives from the BS a second message including second relay capability information indicating if the BS supports the RS capability for the node, and operates as an RS or as a general node according to the second relay capability information of the second message. The BS determines whether to select the node as an RS according to the first message, configures the second message including the second relay capability information according to the determination, and sends the second message to the node.

According to further another aspect of the present invention, in an apparatus for negotiating RS capability in a multi-hop relay cellular communication system, a node configures a first message including first relay capability information indicating if a node supports an RS capability, sends the first message to an upper-layer RS, receives a fourth message including second relay capability information indicating if a BS supports the RS capability, and operates as an RS or as a general node according to the second relay capability information of the fourth message. The upper-layer RS determines from the first message if the node supports the RS capability, configures a second message including the first relay capability information and an ID of the node, sends the second message to the BS, receives a third message including the second relay capability information and the ID of the node, configures a fourth message including the second relay capability information, and sends the fourth message to the node. The BS receives the second message from the upper-layer RS, determines whether to select the node as an RS according to the second message, configures the third message including the second relay capability information and the ID of the node according to the determination, and sends the third message to the upper-layer RS.

According to still another aspect of the present invention, in a method of negotiating RS capability in a node in a multi-hop relay cellular communication system, the node configures a first message including first relay capability information indicating if a node supports an RS capability, sends the first message to a BS, receives a second message including second relay capability information indicating if the BS supports the RS capability for the node from an upper-layer RS or the BS, and operates as an RS or as a general node according to the second relay capability information of the second message.

According to still further aspect of the present invention, in a method of negotiating RS capability in a BS in a multi-hop relay cellular communication system, the BS receives from a node or an upper-layer RS a first message including first relay capability information indicating if the node supports an RS capability, and determines whether to select the node as an RS. The BS then configures a second message including second relay capability information indicating if the node is selected as the RS according to the determination and sends the second message to the node or the upper-layer RS.

According to yet another aspect of the present invention, in a method of negotiating RS capability in an upper-layer RS in a multi-hop relay cellular communication system, the upper-layer RS receives from a node a first message including first relay capability information indicating if the node supports an RS capability and determines if the node supports an RS capability from the first message. The upper-layer RS configures a second message including the first relay capability information and an ID of the node according to the determination and sends the second message to a BS. The upper-layer RS receives from the BS a third message including second relay capability information indicating if the node is selected as the RS and the ID of the node, configures a fourth message including the second relay capability information, and sends the fourth message to the node.

According to yet further aspect of the present invention, in a method of negotiating RS capability in a multi-hop relay cellular communication system, a node configures a first message including first relay capability information indicating if the node supports an RS capability and sends the first message to an upper-layer RS. The upper-layer RS forwards the first message to a BS. Upon receipt of the first message, the BS determines whether to select the node as an RS, configures a second message including second relay capability information indicating if the node is selected as the RS, and sends the second message to the upper-layer RS. The upper-layer RS forwards the second message to the node. The node operates as the RS or as a general node according to the second relay capability information of the second message.

According to yet further another aspect of the present invention, in an apparatus for negotiating RS capability in a multi-hop relay cellular communication system, a node configures a first message including first relay capability information indicating if the node supports an RS capability, sends the first message to an upper-layer RS, receives from the upper-layer RS a second message including second relay capability information indicating if the node is selected as an RS, and operates as the RS or a general node according to the second relay capability information. The upper-layer RS receives the first message from the node, forwards the first message to a BS, receives the second message from the BS, forwards the second message to the node, receives an indicate message from the BS, and acquires the second relay capability information from the indicate message. Upon receipt of the first message from the upper-layer RS, the BS determines whether to select the node as the RS, configures the second message including the second relay capability information according to the determination, sends the second message to the upper-layer RS, and then sends the indicate message including the second relay capability information to the upper-layer RS.

According to still yet another aspect of the present invention, in a method of negotiating RS capability in an upper-layer RS in a multi-hop relay cellular communication system, the upper-layer RS receives from a node a first message including first relay capability information indicating if the node supports an RS capability and forwards the first message to a BS. The upper-layer RS receives from the BS a second message including second relay capability information indicating if the node is selected as the RS and forwards the second message to the node.

According to another further aspect of the present invention, in a method of negotiating RS capability in a BS in a multi-hop relay cellular communication system, the BS receives from an upper-layer RS a first message including first relay capability information indicating if a node supports an RS capability, determines whether to select the node as an RS, configures a second message including second relay capability information indicating if the node is selected as the RS, and sends the second message to the upper-layer RS. The BS then sends an indicate message including the second relay capability information to the upper-layer RS.

### BRIEF DESCRIPTION OF THE DRAWINGS

The above and other objects, features and advantages of the present invention will become more apparent from the following detailed description when taken in conjunction with the accompanying drawings in which:

FIG. 1 illustrates the configuration of a typical IEEE 802.16e communication system;

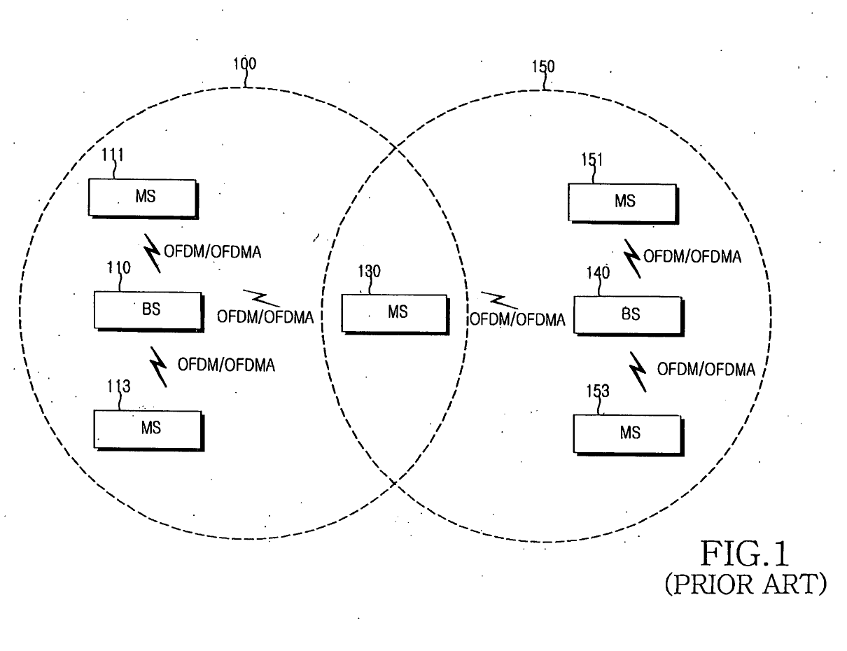

FIG. 2 illustrates the configuration of a multi-hop relay BWA communication system configured to expand the cell coverage of BSs;

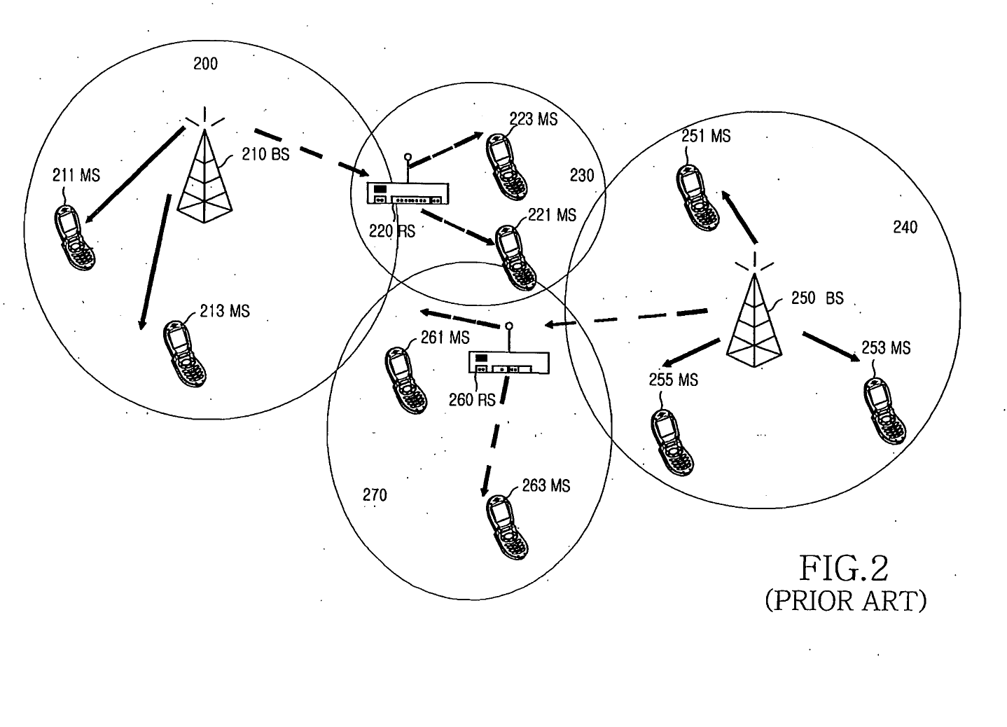

FIG. 3 illustrates the configuration of a multi-hop relay BWA communication system configured to increase system capacity;

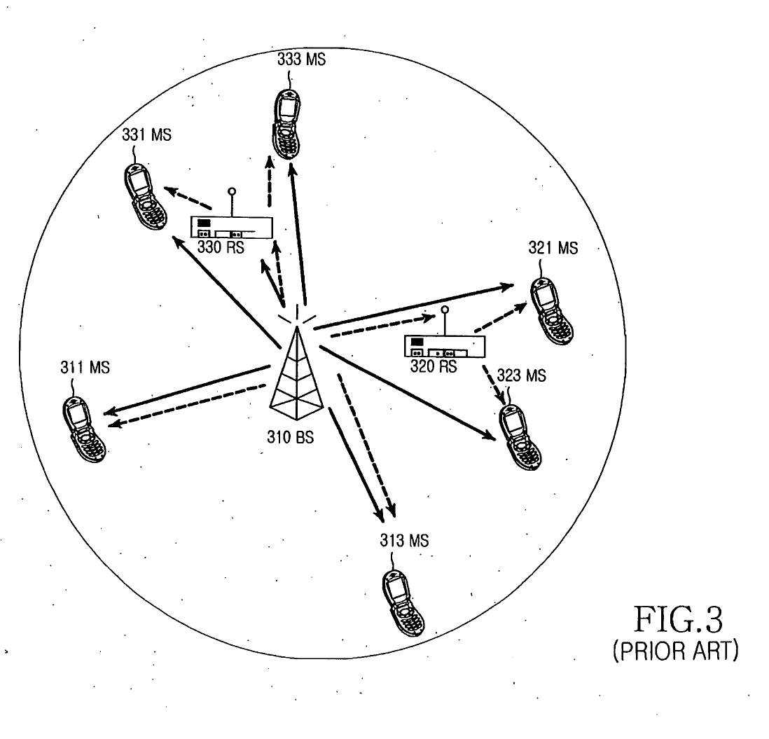

FIG. 4 is a diagram illustrating a signal flow for negotiating RS capability support between a node and a BS during direct communications between them in a multi-hop relay BWA communication system according to the present invention;

FIG. 5 is a diagram illustrating a signal flow for negotiating RS capability support among a node, an upper-layer RS, and the BS during relay communications via the upper-layer RS in the multi-hop relay BWA communication system according to the present invention;

FIG. 6 is a diagram illustrating a signal flow for negotiating RS capability support between the node and the BS during direct communications between them in the multi-hop relay BWA communication system according to the present invention;

FIG. 7 is a diagram illustrating a signal flow for negotiating RS capability support among the node, the upper-layer RS, and the BS during relay communications via the upper-layer RS in the multi-hop relay BWA communication system according to the present invention;

FIG. 8 is a block diagram of the node (the upper-layer RS or the BS) according to the present invention; and

FIG. 9 is a diagram illustrating a signal flow for negotiating RS capability support among the node, the upper-layer RS, and the BS in the multi-hop relay BWA communication system according to the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

The present invention provides a signaling procedure for negotiating RS capability support between a serving BS and a node during an initial connection procedure in a multi-hop relay BWA communication system.

The multi-hop relay BWA communication system operates in OFDM/OFDMA, by way of example. As a physical channel signal is delivered on a plurality of subcarriers, the OFDM/OFDMA operation enables high-speed data transmission. Also, the MS's mobility is supported because the multi-hop relay BWA communication system is configured in a multi-cell structure.

While the following description is made in the context of a BWA communication system, it is to be clearly understood that the present invention is applicable to any multi-hop relay communication system.

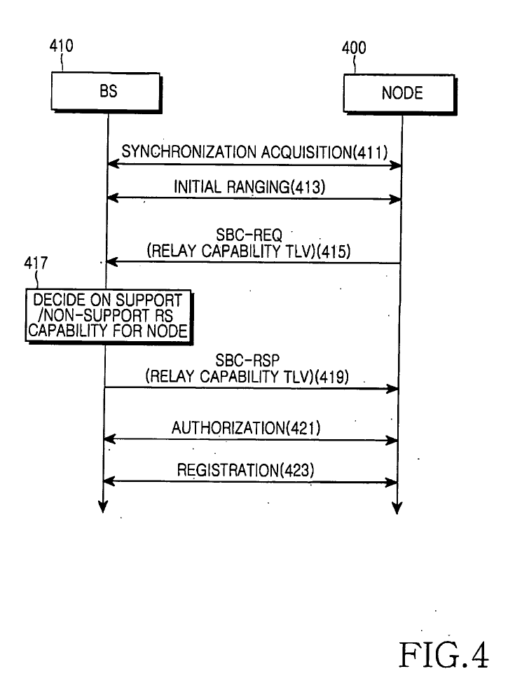

FIG. 4 is a diagram illustrating a signal flow for negotiating RS capability support between a node and a BS during direct communications between them in the multi-hop relay BWA communication system according to the present invention.

Referring to FIG. 4, upon power-on, a node 400 recognizes a BS 410 as its serving station and acquires system synchronization with the BS 4 10 using a downlink preamble received from the BS 410 in step 411. The node 400 performs an initial ranging procedure with the BS 410 in step. 413 and sends an SS Basic Capability Request (SBC-REQ) message to the BS 410 to start a basic capabilities negotiation procedure in step 415. The SBC-REQ message contains information about basic capabilities that the node 400 supports to communicate with the BS 410, such as physical layer parameters. According to the present invention, the SBC-REQ message further includes relay capability information indicating if the node 400 supports the RS function.

The relay capability information included in the SBC-REQ message is illustrated in Table 1 below.

TABLE 1

| | Type | Length | |
|---|---|---|---|
| Name | (1 byte) | (bytes) | Value |
| RS | TBD | 1 | Bit #0: RS support; if the bit is set to 0, |
| capa- | | | the node does not support relay function, |
| bility | | | if the bit set to 1, the node supports relay |
| | | | function. |
| | | | Bit #1: Fixed RS support |
| | | | Bit #2: Nomadic RS support |
| | | | Bit #3: Mobile RS support |
| | | | Bit #4: Infrastructure RS support |
| | | | Bit #5: Client RS support |
| | | | Bit #6-7: reserved; shall be set to zero |
| | | | Notes: if bit #0 is set to zero, the other |
| | | | bits shall be set to zero. |

Referring to Table 1, the RS capability encoding information of the present invention includes an encoding name (RS capability), an encoding type (To Be Determined: TBD), and an encoding size (Length: 1 369 byte), and an encoding value (Value). In the Value, bit #0 indicates if the node 400 supports the RS function. If bit #0 is 0, which implies that the node 400 does not support the RS function, the other seven bits of the Value are set to 0s. Bit #0 set to 1 implies that the node 400 supports the RS function. Bit #1 to bit #5 indicate if the node 400 supports a fixed RS capability, a nomadic RS capability, a mobile RS capability, an infrastructure RS capability, or a client RS capability.

Upon receipt of the SBC-REQ message, the BS 410 determines whether to select the node 400 as an RS in step 417. The determination depends on if the BS 410 aims to expand its coverage or increase system capacity. In step 419, the BS 410 replies to the node 400 with an SS Basic Capability Response (SBC-RSP) message containing the determination result. The SBC-RSP message includes all parameters corresponding to parameters included in the SBC-REQ message. For example, when receiving the SBC-REQ message having the relay capability information illustrated in Table 1, the BS 410 sends an SBC-RSP message including parameters corresponding to the relay capability information, as illustrated in Table 2.

TABLE 2

| | Type | Length | |
|---|---|---|---|
| Name | (1 byte) | (bytes) | Value |
| RS | TBD | 1 | Bit #0: RS support confirm; if the bit is |
| capa- | | | set to 0, the receiver node shall not |
| bility | | | support relay function, if the bit set to 1, |
| | | | the receiver node supports relay function. |
| | | | Bit #1: Fixed RS support confirm |
| | | | Bit #2: Nomadic RS support confirm |
| | | | Bit #3: Mobile RS support confirm |
| | | | Bit #4: Infrastructure RS support |
| | | | Bit #5: Client RS support |
| | | | Bit #6-7: reserved; shall be set to zero |
| | | | Notes: if bit #0 is set to zero, the other |
| | | | bits shall be set to zero. |
| | | | Notes: if each bit is set to 0 in ‘RS |
| | | | capability’ of Table 1, the corresponding |
| | | | bit in Table 2 shall not be set to 1. |

Referring to Table 2, the RS capability encoding information of the present invention includes an encoding name (RS capability), an encoding type (To Be Determined: TBD), and an encoding size (Length: 1 byte), and an encoding value (Value). In the Value, bit #0 indicates if the BS 410 selects the node 400 as an RS. Bit #0 equal to 0 implies that the BS 410 does not confirm the RS function support of the node 400. Therefore, the other seven bits of the Value are set to 0s. Bit #0 set to 1 implies that the BS 410 confirms the RS function support of the node 400. When the node 400 receives an SBC-RSP message with bit #0 set to 1, the node 400 functions as an RS. In step 415, unless bit #0 is set to 1 in the Value of RS capability in the received SBC-REQ message, the BS 410 does not set bit #0 of the Value of RS capability in the SBC-RSP message to 1 because the node 400 does not support the RS function.

Bit #1 to bit #5 of the Value indicate if the BS 410 confirms a fixed RS capability, a nomadic RS capability, a mobile RS capability, an infrastructure RS capability, or a client RS capability for the node 400. These bits are set to correspond to the corresponding bits of the Value of RS capability in the SBC-REQ message, and the BS 410 sets a corresponding bit to 0 for an RS capability that the node 400 does not support.

The relay capability information of Table 1 in the SBC-REQ message may have the same encoding type as that of Table 2 in the SBC-RSP message, and the relay capability information of the two messages is illustrated in the separate tables in order to clearly distinguish their meanings.

After the basic capabilities negotiation procedure in step 415 through step 419, the node 400 and the BS 410 perform an authorization procedure required for communications between them in step 421. The authorization may vary depending on the RS capability-related determination made in step 415 through step 419. The authorization procedure is beyond the scope of the present invention and thus will not be described herein in detail. The node 400 then registers to the BS 410 in step 423.

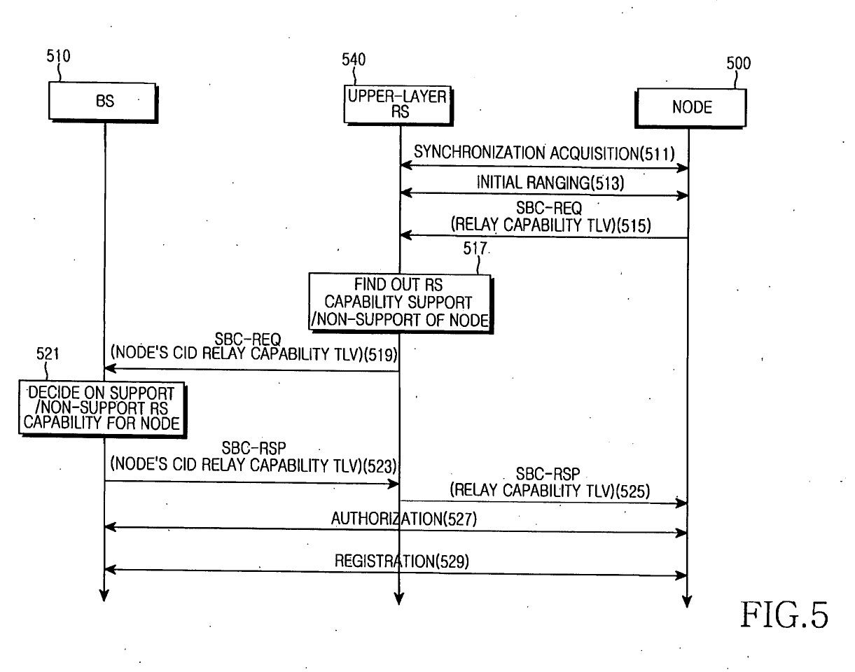

FIG. 5 is a diagram illustrating a signal flow for negotiating RS capability support among a node, an upper-layer RS, and a BS during relay communications via the upper-layer RS in the multi-hop relay BWA communication system according to the present invention.

Referring to FIG. 5, upon power-on, a node 500 recognizes an upper-layer 540 as its serving station and acquires system synchronization with the upper-layer RS 540 using a downlink preamble received from the upper-layer RS 540 in step 511. The node 500 performs an initial ranging procedure with the upper-layer RS 540 in step 513 and sends an SBC-REQ message to the upper-layer RS 540 to start a basic capabilities negotiation procedure in step 515. The SBC-REQ message contains information about basic capabilities that the node 500 supports, such as physical layer parameters. According to the present invention, the SBC-REQ message further includes relay capability information illustrated in Table 1. The upper-layer RS 540 determines if the node 500 supports RS function from the SBC-REQ message in step 517.

If it is determined that the node 500 supports the RS function, the upper-layer layer RS 540 forwards the SBC-REQ message to a BS 510 to send the relay capability information of the node 500 in step 519. The SBC-REQ message contains the Identifier (ID) of the node 500 and the relay capability information included in the SBC-REQ message as illustrated in Table 1. The ID of the node 500 may be the Medium Access Control (MAC) address of the node 500 or a basic Connection Identifier (CID) allocated to the node 500.

In step 521, the BS 510 determines whether to select the node 500 as an RS. The determination depends on whether the BS 510 aims to expand its coverage or increase system capacity. In step 523, the BS 510 replies to the upper-layer RS 540 with an SBC-RSP message containing the determination result. The SBC-RSP message includes the ID of the node 500 and relay capability information indicating the determination result as illustrated in Table 2. That is, the relay capability information indicates if an RS capability is confirmed for the node 500.

The upper-layer RS 540 configures an SBC-RSP message with the relay capability information determined by the BS 510 and other basic capability information for the node 500 and sends the SBC-RSP message to the node 500 in step 525. If the SBC-RSP message has bit #0 set to 1 in the Value of RS capability illustrated in Table 2, the node 500 functions as an RS.

In steps 519 and 523, the upper-layer RS 540 and the BS 510 may send the relay capability information of the node 500 by a new message other than the SBC-REQ/RSP message. Obviously, the new message includes the ID of the node 500 and the relay capability information of the node 500. If an RS capability is confirmed for the node 500, RS preamble information for the node 500 may be further included in the new message carrying the relay capability information from the BS 510.

After the basic capabilities negotiation procedure in step 515 through step 525, the node 500, the upper-layer RS 540, and the BS 510 perform an authorization procedure required for communications in step 527. The authorization may vary depending on the RS capability-related determination made in step 415 through step 419. The authorization procedure is beyond the scope of the present invention and thus will not be described herein in detail. The node 500 then registers to the BS 510 via the upper-layer RS 540 in step 529.

If the upper-layer RS 540 receives an SBC-REQ message with bit #0 set to 0 in the Value of RS capability in step 515, the upper-layer RS 540 determines that the node 500 does not support the RS function. In this case, there is no need for the BS 510 to determine whether to confirm an RS capability for-the node 500 and thus steps 519, 521 and 523 may not need to be performed.

In the above description illustrated in FIGS. 4 and 5, the BS decides whether to support an RS capability for the node by exchanging the SBC-REQ message and the SBC-RSP message during the basic capabilities negotiations in the initial connection procedure. The RS capability support negotiation may take place in another phase of the initial connection procedure other than the basic capabilities negotiation. The RS capability support negotiation can also be performed during the registration procedure.

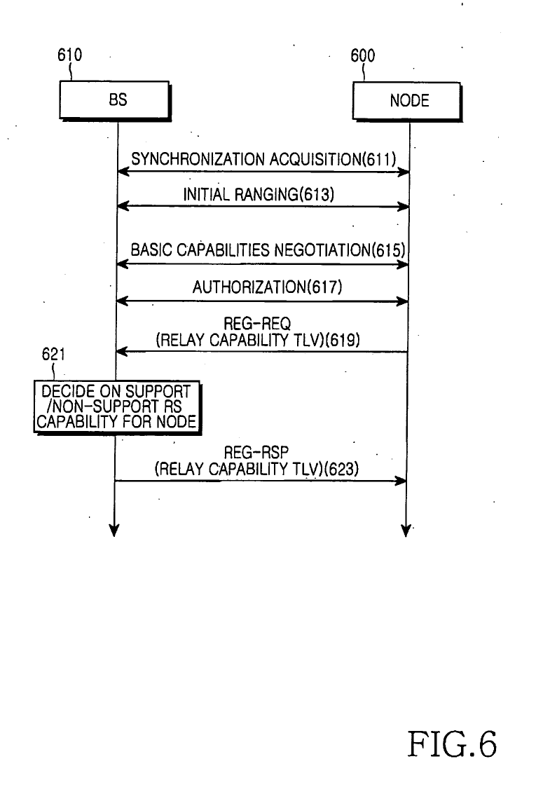

FIG. 6 is a diagram illustrating a signal flow for negotiating RS capability support between a node and a BS during direct communications between them in the multi-hop relay BWA communication system according to the present invention.

Referring to FIG. 6, upon power-on, a node 600 recognizes a BS 610 as its serving station and acquires system synchronization with the BS 610 using a downlink preamble received from the BS 610 in step 611. The node 600 performs an initial ranging procedure with the BS 610 in step 613 and performs a basic capabilities negotiation procedure by exchanging SBC-REQ and SBC-RSP messages with the BS 610 in step 615. The SBC-REQ and SBC-RSP messages contain information about basic capabilities that the node 600 supports to communicate with the BS 610, such as physical layer parameters. In step 617, the node 600 performs an authorization procedure required for communications with the BS 610.

In step 619, the node 600 sends a Registration Request (REG-REQ) message to the BS 610, for registration. The REG-REQ message may contain relay capability information indicating if the node 600 supports RS function, as illustrated in Table 1. Upon receipt of the REG-REQ message, the BS 610 determines whether to select the node 600 as an RS in step 621. The determination depends on whether the BS 610 aims to expand its coverage or increase system capacity. In step 623, the BS 610 replies to the node 600 with a Registration Response (REG-RSP) message containing the determination result. The REG-RSP message includes all parameters corresponding to parameters included in the REG-REQ message. For example, when receiving the REG-REQ message having the relay capability information illustrated in Table 1, the BS 610 sends an REG-RSP message including relay capability information illustrated in Table 2. Bit #0 in the Value of the RS capability illustrated in Table 2 set to 1 implies that the BS 610 confirms an RS capability for the node 600. If the node 600 receives the REG-RSP message with bit #0 set to 1 in the Value of the RS capability, the node 600 functions as an RS. If the REG-REQ message has bit #0 set to 0 in the Value of RS capability, which implies that the node 600 does not support the RS function, the BS 610 does not set bit #0 to 1 in the Value of the RS capability of the REG-RSP message.

Bit #1 to bit #5 in the Value of the RS capability in the REG-RSP message indicate if the BS 610 supports a fixed RS capability, a nomadic RS capability, a mobile RS capability, an infrastructure RS capability, or a client RS capability for the node 600. These bits are set to correspond to the corresponding bits of the Value of the RS capability in the REG-REQ message, and the BS 610 sets a corresponding bit to 0 for an RS capability that the node 600 does not support.

If bit #0 is set to 1 in the Value of the RS capability of the REG-RSP message, which implies that the BS 610 confirms an RS capability for the node 600, RS preamble information for the node 600 may be further included in the REG-RSP message.

The RS preamble information is configured as illustrated in Table 3 below.

TABLE 3

| Name | Type (1 byte) | Length (bytes) | Value |
|---|---|---|---|
| RS preamble info | TBD | 1 | Information of RS |
| | | | preamble |

Referring to Table 3, the preamble encoding information includes an encoding name (RS preamble info), an encoding type (TBD), an encoding size (Length: 1 byte), and an encoding value (Value) representing RS preamble information for the node for which an RS capability has been confirmed. The RS preamble information provides a preamble index or any other information identifying a preamble sequence that the node 600 will send as an RS in its coverage area.

The node 600, which has received the REG-RSP message and will function as an RS, sends a preamble sequence indicated by the RS preamble information illustrated in Table 3. The configuration and transmission of the preamble sequence from the node 600 are beyond the scope of the present invention and will not be described herein in detail.

The relay capability information of Table 1 in the REG-REQ message may have the same encoding type as that of Table 2 in the REG-RSP message, and the relay capability information of the two messages is illustrated in the separate tables in order to clearly distinguish their meanings.

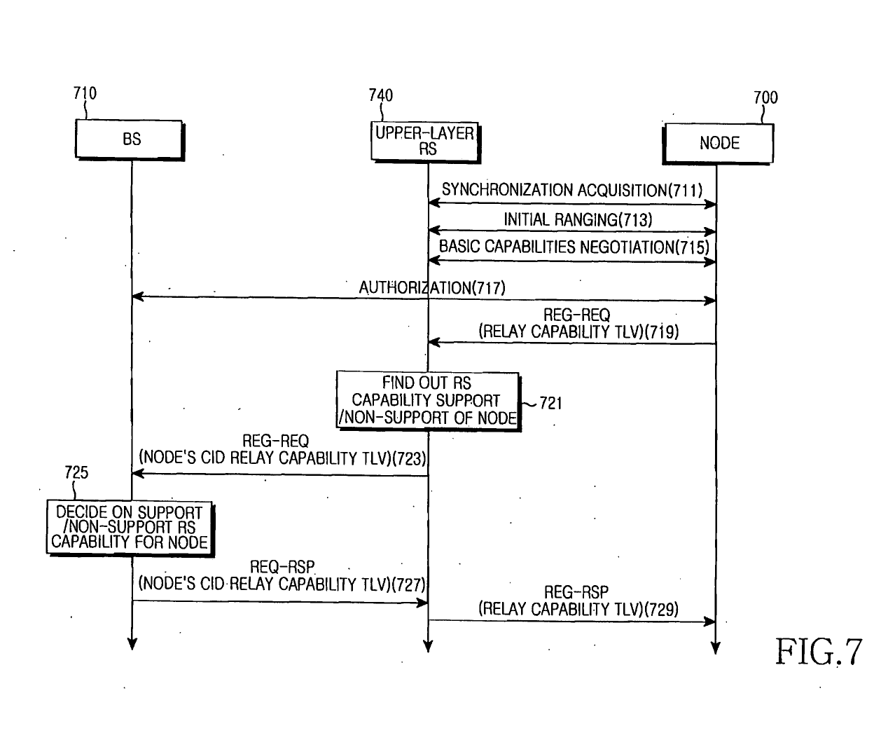

FIG. 7 is a diagram illustrating a signal flow for negotiating RS capability support among a node, an upper-layer RS, and a BS during relay communications via the upper-layer RS in the multi-hop relay BWA communication system according to the present invention.

Referring to FIG. 7, upon power-on, a node 700 recognizes an upper-layer RS 740 as its serving station and acquires system synchronization with the upper-layer RS 740 using a downlink preamble received from the upper-layer RS 740 in step 711. The node 700 performs an initial ranging procedure with the upper-layer RS 740 in step 713 and exchanges an SBC-REQ message and an SBC-RSP message with the upper-layer RS 740 to start a basic capabilities negotiation procedure in step 715. The SBC-REQ and SBC-RSP messages contain information about basic capabilities that the node 700 supports, such as physical layer parameters. Authorization is performed between the node 700 and a BS 710 via the upper-layer RS 740 in step 717.

The node 700 sends an REG-REQ message to the upper-layer RS 740 to register to the BS 710 via the upper-layer RS 740 in step 719. The REG-REQ message may contain relay capability information indicating illustrated in Table 1. Upon receipt of the REG-REQ message, the upper-layer RS 740 determines whether the node 700 supports RS function in step 721.

If it is determined that the node 700 supports the RS function, the upper-layer RS 740 forwards the REG-REQ message to the BS 710 to send the relay capability information of the node 700 in step 723. The REG-REQ message contains the ID of the node 700 and the relay capability information included in the REG-REQ message. The ID of the node 700 may be the MAC address of the node 700 or a basic CID allocated to the node 700.

In step 725, the BS 710 determines whether to select the node 700 as an RS. The determination depends on whether the BS 710 aims to expand its coverage or increase system capacity. In step 727, the BS 710 replies to the upper-layer RS 740 with an REG-RSP message containing the determination result. The REG-RSP message includes the ID of the node 700 and relay capability information indicating the determination result as illustrated in Table 2. That is, the relay capability information indicates if an RS capability is confirmed for the node 700. The BS 710 may further include RS preamble information illustrated in Table 3 for the node 700 in the REG-RSP message.

In step 729, the upper-layer RS 740 configures an REG-RSP message with the relay capability information determined by the BS 710 and other capability information required for the registration of the node 700 as included in the REG-REQ message and sends the REG-RSP message to the node 700. If the REG-RSP message received from the BS 710 has bit #0 set to 1 in the Value of RS capability configured as illustrated in Table 2 and includes the RS preamble information configured as illustrated in Table 3, the upper-layer RS 740 includes the same information in the REG-RSP message to be sent to the node 700 in step 729. Upon receipt of the REG-RSP message with bit #0 set to 1 in the Value of the RS capability, the node 700 functions as an RS and sends its preamble sequence based on the RS preamble information.

In steps 723 and 727, the upper-layer RS 740 and the BS 710 may send the relay capability information of the node 700 by a new message other than the REG-REQ/RSP message. Obviously, the new message sent from the BS 710 includes the ID, relay capability information, and RS preamble information of the node 700.

If the upper-layer RS 740 receives an REG-REQ message with bit #0 set to 0 in the Value of the RS capability in step 719, the upper-layer RS 740 determines that the node 700 does not support the RS function. In this case, there is no need for the BS 710 to determine whether to confirm an RS capability for the node 700 and thus steps 723, 725 and 727 may not need to be performed.

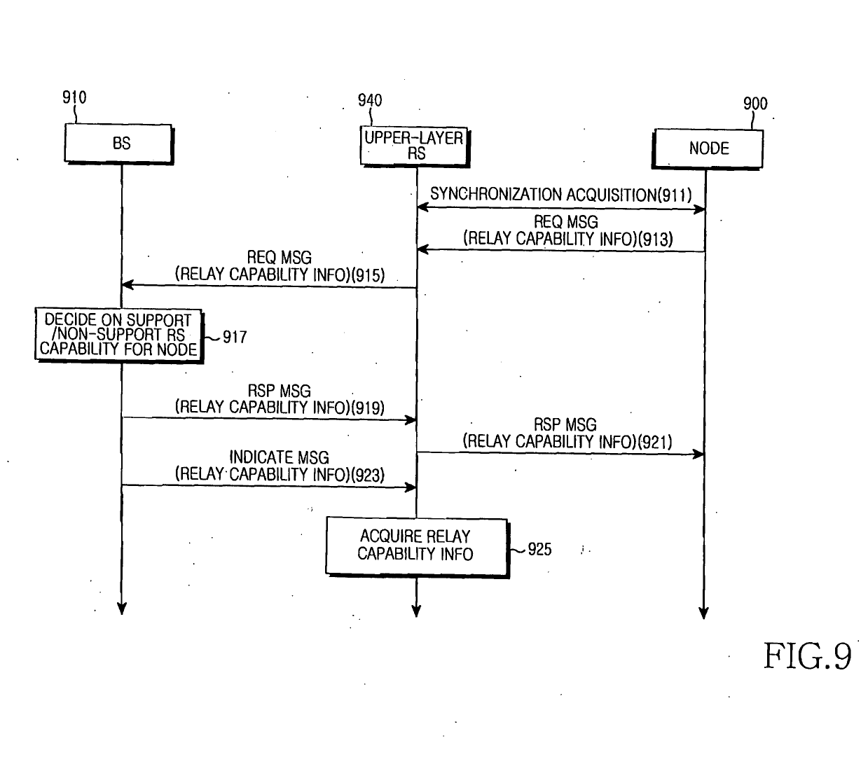

FIG. 9 is a diagram illustrating a signal flow for negotiating RS capability support among a node, an upper-layer RS, and a BS during relay communications via the upper-layer RS in the multi-hop relay BWA communication system according to the present invention. The upper-layer RS simply forwards messages between the node and the BS without interpreting the messages.

Referring to FIG. 9, a node 900 acquires system synchronization with an upper-layer RS 940 in step 911 and sends a request message (REQ MSG) to the upper-layer RS 940 in order to establish a connection to a BS 910 via the upper-layer RS 940 in step 913. The REQ MSG contains relay capability information of the node 900. In step 915, the upper-layer RS 940 forwards the REQ MSG to the BS 910.

The BS 910 processes the contents of the REQ MSG and also determines whether to support an RS capability for the node 900 by processing the relay capability information in step 917 and replies to the upper-layer RS 940 with a response message (RSP MSG) containing relay capability information representing the determination result in step 919. The upper-layer RS 940 then forwards the RSP MSG to the node 900 in step 921.

In step 923, the BS 910 sends to the upper-layer RS 940 an indicate message (INDICATE MSG) containing the relay capability information and parameters required for communications between the node 900 and the upper-layer RS 940. Thus, the upper-layer RS 940 acquires the relay capability information of the node 900 and the parameters required for communications with the node 900 in step 925.

A description will now be made of the configurations of the node, the upper-layer RS, and the BS. Since the node, the upper-layer RS and the BS have identical interface modules (communication modules), their operations will be described with respect to a single device.

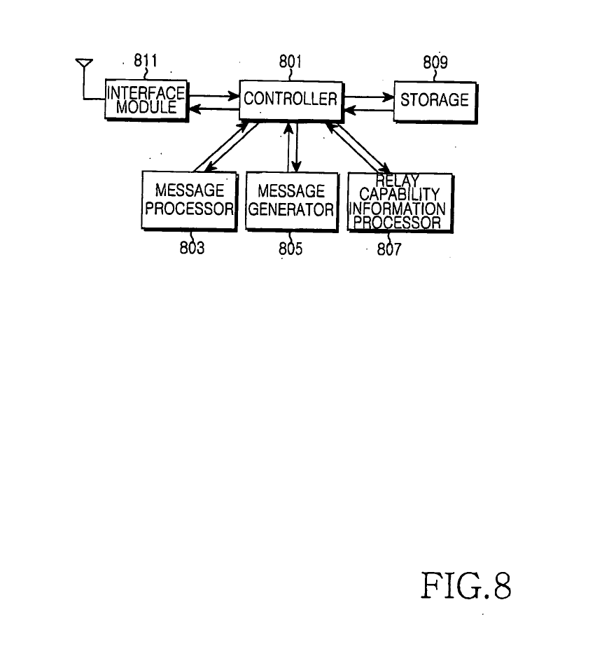

FIG. 8 is a block diagram of the node (the upper-layer RS or the BS) according to the present invention. The following description focuses on processing a control message.

Referring to FIG. 8, in the node, a controller 801 provides overall control to the node. For example, the controller 801 processes and controls voice communication and data communication. In addition to the typical functionalities, the controller 801 performs an operation associated with RS capability negotiation according to the present invention. The controller 801 provides a control message received from the upper-layer RS or the BS to a message processor 803, and provides a transmission message for the upper-layer RS or the BS received from a message generator 805 to an interface module 811.

The message processor 803 disassembles the control message received from the upper-layer RS or the BS and notifies the controller 801 of the result. According to the present invention, upon receipt of an SBC-RSP or REG-RSP message including relay capability information illustrated in Table 2, the message processor 803 extracts the control information from the message and provides the control information to the controller 801. The controller 801 then controls a relay capability information processor 807 in accordance with the control information.

The message generator 805 generates an SBC-REQ or REG-REQ message with relay capability information illustrated in Table 1 to be transmitted to the upper-layer RS or the BS under the control of the controller 801 and provides the message to the interface module 811 through the controller 801.

The relay capability information processor 807 provides information required for performing a communication procedure with the upper-layer RS or the BS corresponding to the relay capability parameters to the controller 801.

A storage 809 stores programs for controlling the overall operations of the node and temporary data generated during the execution of the programs. The storage 809 can store data and control information that the node will send to the upper-layer RS or the BS.

The interface module 811 is used to communicate with the upper-layer RS or the BS, including a Radio Frequency (RF) processor and a baseband processor. The RF processor downconverts a signal received through an antenna to a baseband signal and provides the baseband signal to the baseband processor. For transmission, the RF processor upconverts a baseband signal received from the baseband processor to an RF signal and sends the RF signal in the air through the antenna. If a BWA scheme is used, the baseband processor Fast Fourier Transform (FFT)-processes the signal received from the RF processor, channel-decodes the FFT signal, and provides the resulting original information data to the controller 801. For transmission, the baseband processor channel-encodes and Inverse Fast Fourier Transform (IFFT)-processes data received from the controller 801 and provides the IFFT signal to the RF processor.

With reference to FIG. 8, the structure of the upper-layer RS will be described.

Referring to FIG. 8, in the upper-layer RS, the controller 801 provides overall control to the upper-layer RS. For example, the controller 801 processes and controls voice communication and data communication. In addition to the typical functionalities, the controller 801 performs an operation associated with RS capability negotiation according to the present invention. The controller 801 provides a control message received from the node or the BS to the message processor 803, and provides a transmission message for the node or the BS received from the message generator 805 to the interface module 811.

The message processor 803 disassembles the control message received from the node or the BS and notifies the controller 801 of the result. According to the present invention, upon receipt of an SBC-REQ or REG-REQ message including relay capability information illustrated in Table 1 from the node, or upon receipt of an SBC-RSP or REG-RSP message including relay capability information illustrated in Table 2 or an equivalent message from the BS, the message processor 803 extracts the control information from the message and provides the control information to the controller 801. The controller 801 then operates in accordance with the control information.

The message generator 805 generates an SBC-REQ or REG-REQ message with relay capability information illustrated in Table 1 to be transmitted to the BS, or an SBC-RSP or REG-RSP message with relay capability information illustrated in Table 2 to be transmitted to the node under the control of the controller 801, and provides the message to the interface module 811 through the controller 801.

The relay capability information processor 807 manages the relay capability information to be sent to the node managed by the upper-layer RS under the control of the controller 801.

The storage 809 stores programs for controlling the overall operations of the upper-layer RS and temporary data generated during the execution of the programs. The storage 809 can store data and control information that the upper-layer RS will send to the node or the BS.

The interface module 811 is used to communicate with the node or the BS, including the RF processor and the baseband processor. The RF processor downconverts a signal received through an antenna to a baseband signal and provides the baseband signal to the baseband processor. For transmission, the RF processor upconverts a baseband signal received from the baseband processor to an RF signal and sends the RF signal in the air through the antenna. If a BWA scheme is used, the baseband processor FFT-processes the signal received from the RF processor, channel-decodes the FFT signal, and provides the resulting original information data to the controller 801. For transmission, the baseband processor channel-encodes and IFFT-processes data received from the controller 801 and provides the IFFT signal to the RF processor.

With reference to FIG. 8, the structure of the BS will be described.

Referring to FIG. 8, in BS, the controller 801 provides overall control to the BS. For example, the controller 801 processes and controls voice communication and data communication. In addition to the typical functionalities, the controller 801 performs an operation associated with negotiation of an RS capability with the node according to the present invention. The controller 801 provides a control message received from the node or the upper-layer RS to the message processor 803, and provides a transmission message for the node or the upper-layer RS received from the message generator 805 to the interface module 811.

The message processor 803 disassembles the control message received from the node or the upper-layer RS and notifies the controller 801 of the result. According to the present invention, upon receipt of an SBC-REQ or REG-REQ message including relay capability information illustrated in Table 1 from the upper-layer RS or the node, the message processor 803 extracts the control information from the message and provides the control information to the controller 801. The controller 801 then operates in accordance with the control information.

The message generator 805 generates messages to be set to the node to the upper-layer RS under the control of the controller and provides the messages to the controller 801. According to the present invention, the message generator 805 generates an SBC-RSP or REG-RSP message with relay capability information illustrated in Table 2 to be transmitted to the node under the control of the controller 801. The message generator 805 also generates an SBC-RSP or REG-RSP message with relay capability information illustrated in Table 2 or an equivalent message to be transmitted to the upper-layer RS under the control of the controller 801. In addition, the message generator 805 generates RS preamble information for the node that will function as an RS. The generated messages are provided to the interface module 811 through the controller 801.

The relay capability information processor 807 manages nodes that negotiate RS capabilities with the BS under the control of the controller 801. Also, the relay capability information processor 807 determines to select a node that supports an RS capability as an RS and determines to send RS preamble information for the selected node according to the present invention.

The storage 809 stores programs for controlling the overall operations of the BS and temporary data generated during the execution of the programs. The storage 809 can store data and control information that the BS will send to the node or the upper-layer RS.

The interface module 811 is used to communicate with the node or the upper-layer RS, including the RF processor and the baseband processor. The RF processor downconverts a signal received through an antenna to a baseband signal and provides the baseband signal to the baseband processor. For transmission, the RF processor upconverts a baseband signal received from the baseband processor to an RF signal and sends the RF signal in the air through the antenna. If a BWA scheme is used, the baseband processor FFT-processes the signal received from the RF processor, channel-decodes the FFT signal, and provides the resulting original information data to the controller 801. For transmission, the baseband processor channel-encodes and IFFT-processes data received from the controller 801 and provides the IFFT signal to the RF processor.

In the above-described configurations of the node, the upper-layer RS, and the BS, the controller 801 controls the message processor 803, the message generator 805, and the relay capability information processor 807. The controller 801 can perform the functions of the message processor 803, the message generator 805, and the relay capability information processor 807. While the message processor 803, the message generator 805, and the relay capability information processor 807 are shown separately in FIG. 8 for illustrative purposes, all or part of their functions may be incorporated into the controller 801 in actual implementation.

In accordance with the present invention as described above, in an OFDM/OFDMA BWA communication system, particularly in a multi-hop relay broadband wireless communication system using an RS for establishing a multi-hop relay path between a MS and a BS between which the direct link is in a bad channel status, a node supporting RS function can negotiate an RS capability with a serving BS during an initial connection procedure. Therefore, a signaling procedure necessary to decide if the node is to function as an RS is provided. Furthermore, the same services and functions can be provided via the RS as if the MS and the BS were communicating with each other via the direct link.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A method of negotiating Relay Station (RS) capability in a communication system, comprising the steps of:
configuring by a node a first message including first relay capability information indicating if the node supports an RS capability and sending by the node the first message to a Base Station (BS);
determining by the BS whether to select the node as an RS according to the first message, configuring by the BS a second message including second relay capability information indicating if the node is selected as the RS according to the determination, and sending by the BS the second message to the node; and
receiving by the node the second message and operating the node as an RS or as a general node according to the second relay capability information of the second message.

2. The method of claim 1, further comprising acquiring by the node system synchronization and performing by the node an initial ranging procedure with the BS, before the first message configuration step.

3. The method of claim 2, further comprising performing by the node an authorization procedure and a registration procedure with the BS, after the second message reception step.

4. The method of claim 1, further comprising acquiring by the node system synchronization and performing by the node the initial ranging procedure, a basic capabilities negotiation procedure, and the authorization procedure with the BS, before the first message configuration step.

5. The method of claim 1, wherein, if the BS selects the node as an RS, the BS includes the second relay capability information and RS preamble information in the second message and sends the second message to the node.

6. The method of claim 5, wherein the operating step comprises operating the node as the RS, and sending by the node a preamble sequence indicated by the RS preamble information.

7. The method of claim 1, wherein the determination step comprises determining whether to select the node as the RS according to at least one of the purposes of expanding the coverage of the BS and increasing system capacity.

8. The method of claim 1, wherein the RS is at least one of an infrastructure RS installed and managed by the BS, a client RS as which a Mobile Station (MS) serves by supporting RS function, a fixed RS, a nomadic RS, and a mobile RS.

9. A method of negotiating Relay Station (RS) capability in a communication system, comprising the steps of:
configuring by the node a first message including first relay capability information indicating if the node supports an RS capability and sending by the node the first message to an upper-layer RS;
determining by the upper-layer RS if the node supports an RS capability, upon receipt of the first message, configuring by the upper-layer RS a second message including the first relay capability information and an Identifier (ID) of the node if the node supports the RS capability, and sending by the upper-layer RS the second message to a Base Station (BS);
determining by the BS whether to select the node as an RS according to the second message, configuring by the BS a third message including second relay capability information indicating if the node is selected as the RS and the ID of the node according to the determination, and sending by the BS the third message to the upper-layer RS;
configuring by the upper-layer RS a fourth message including the second relay capability information, upon receipt of the third message, and sending by the upper-layer RS the fourth message to the node; and
receiving by the node the fourth message and operating as an RS or as a general node according to the second relay capability information of the fourth message.

10. The method of claim 9, further comprising acquiring by the node system synchronization and performing by the node an initial ranging procedure with the upper-layer RS, before the first message configuration step.

11. The method of claim 10, further comprising performing by the node an authorization procedure and a registration procedure with the upper-layer RS and the BS, after the fourth message reception step.

12. The method of claim 9, further comprising acquiring by the node system synchronization and performing by the node the initial ranging procedure, a basic capabilities negotiation procedure, and the authorization procedure with the upper-layer RS, before the first message configuration step.

13. The method of claim 9, wherein, if the BS selects the node as an RS, the BS includes the second relay capability information, the ID of the node, and RS preamble information in the third message and sends the third message to the upper-layer RS, and
wherein the fourth message configuring and sending step comprises including by the upper-layer RS the second relay capability information and the RS preamble information in the fourth message and sending by the upper-layer RS the fourth message to the node.

14. The method of claim 13, wherein the operating step comprises operating the node as the RS, and sending by the node a preamble sequence indicated by the RS preamble information.

15. The method of claim 9, wherein the determination step comprises determining whether to select the node as the RS according to at least one of the purposes of expanding the coverage of the BS and increasing system capacity.

16. The method of claim 9, wherein the RS is at least one of an infrastructure RS installed and managed by the BS, a client RS as which a Mobile Station (MS) serves by supporting RS function, a fixed RS, a nomadic RS, and a mobile RS.

17. An apparatus for negotiating Relay Station (RS) capability in a communication system, comprising:
a node for configuring a first message including first relay capability information indicating if a node supports an RS capability, sending the first message to a Base Station (BS), receiving from the BS a second message including second relay capability information indicating if the BS selects the node as an RS, and operating as an RS or a general node according to the second relay capability information of the second message; and
the BS for determining whether to select the node as an RS according to the first message, configuring the second message including the second relay capability information according to the determination, and sending the second message to the node.

18. The apparatus of claim 17, wherein the RS is at least one of an infrastructure RS installed and managed by the BS, a client RS as which a Mobile Station (MS) serves by supporting RS function, a fixed RS, a nomadic RS, and a mobile RS.

19. The apparatus of claim 17, wherein the BS determines whether to select the node as the RS according to at least one of the purposes of expanding the coverage of the BS and increasing system capacity.

20. The apparatus of claim 17, wherein if the BS selects the node as an RS, the BS includes the second relay capability information and RS preamble information in the second message and sends the second message to the node.

21. The apparatus of claim 20, wherein upon receipt of the second message, the node operates as the RS and sends a preamble sequence indicated by the RS preamble information.

22. An apparatus for negotiating Relay Station (RS) capability in a communication system, comprising:
a node for configuring a first message including first relay capability information indicating if a node supports an RS capability, sending the first message to an upper-layer RS, receiving a fourth message including second relay capability information indicating if a Base Station (BS) selects the node as an RS, and operating as an RS or as a general node according to the second relay capability information of the fourth message;
the upper-layer RS for determining from the first message if the node supports the RS capability, configuring a second message including the first relay capability information and an Identifier (ID) of the node if the node supports the RS capability, sending the second message to the BS, receiving a third message including the second relay capability information and the ID of the node, configuring a fourth message including the second relay capability information, and sending the fourth message to the node; and
the BS for receiving the second message from the upper-layer RS, determining whether to select the node as an RS according to the second message, configuring the third message including the second relay capability information and the ID of the node according to the determination, and sending the third message to the upper-layer RS.

23. The apparatus of claim 22, wherein the BS determines whether to select the node as the RS according to at least one of the purposes of expanding the coverage of the BS and increasing system capacity.

24. The apparatus of claim 22, wherein the RS is at least one of an infrastructure RS installed and managed by the BS, a client RS as which a Mobile Station (MS) serves by supporting RS function, a fixed RS, a nomadic RS, and a mobile RS.

25. The apparatus of claim 22, wherein if the BS selects the node as an RS, the BS includes the second relay capability information, the ID of the node, and RS preamble information in the third message and sends the third message to the upper-layer RS.

26. The apparatus of claim 25, wherein the upper-layer RS receives the third message, includes the second relay capability information and the RS preamble information set in the third message in the fourth message, and sends the fourth message to the node.

27. The apparatus of claim 26, wherein the node receives the fourth message including the second relay capability information and the RS preamble, operates as the RS, and sends a preamble sequence indicated by the RS preamble information.

28. A method of negotiating Relay Station (RS) capability in a node in a communication system, comprising the steps of:
configuring a first message including first relay capability information indicating if a node supports an RS capability;
sending the first message to a Base Station (BS);
receiving a second message including second relay capability information indicating if the BS selects the node as an RS from an upper-layer RS or the BS; and
operating as an RS or as a general node according to the second relay capability information of the second message.

29. The method of claim 28, further comprising acquiring system synchronization and performing an initial ranging procedure with the upper-layer RS or the BS, before the first message configuration step.

30. The method of claim 29, further comprising performing an authorization procedure and a registration procedure, after the second message reception step.

31. The method of claim 28, further comprising acquiring system synchronization and performing the initial ranging procedure, a basic capabilities negotiation procedure, and the authorization procedure with the upper-layer RS or the BS, before the first message configuration step.

32. The method of claim 31, wherein the operating step comprises operating as the RS and sending a preamble sequence indicated by RS preamble information, if the second message includes the second relay capability information and the RS preamble information.

33. A method of negotiating Relay Station (RS) capability in a Base Station (BS) in a communication system, comprising the steps of:
receiving from a node or an upper-layer RS a first message including first relay capability information indicating if the node supports an RS capability, and determining whether to select the node as an RS;
configuring a second message including second relay capability information indicating if the node is selected as the RS according to the determination; and
sending the second message to the node or the upper-layer RS.

34. The method of claim 33, wherein the determination step comprises determining whether to select the node as the RS according to at least one of the purposes of expanding the coverage of the BS and increasing system capacity.

35. The method of claim 33, further comprising acquiring system synchronization and performing an initial ranging procedure with the node, before the first message reception step.

36. The method of claim 33, further comprising performing an authorization procedure and a registration procedure with the node, after the second message sending step.

37. The method of claim 33, further comprising acquiring system synchronization and performing the initial ranging procedure, a basic capabilities negotiation procedure, and the authorization procedure with the node, before the first message reception step.

38. The method of claim 33, wherein the second message configuring and sending step comprises, if the BS selects the node as an RS, including the second relay capability information and RS preamble information in the second message and sending the second message to the node.

39. A method of negotiating Relay Station (RS) capability in an upper-layer RS in a communication system, comprising the steps of:
receiving from a node a first message including first relay capability information indicating if the node supports an RS capability and determining if the node supports an RS capability from the first message;
configuring a second message including the first relay capability information and an Identifier (ID) of the node if the node supports the RS capability, and sending the second message to a Base Station (BS);
receiving from the BS a third message including second relay capability information indicating if the node is selected as the RS and the ID of the node, configuring a fourth message including the second relay capability information, and sending the fourth message to the node.

40. The method of claim 39, further comprising acquiring system synchronization and performing an initial ranging procedure with the node, before the first message reception step.

41. The method of claim 39, further comprising acquiring system synchronization and performing the initial ranging procedure, a basic capabilities negotiation procedure, and the authorization procedure with the node, before the first message reception step.

42. A method of negotiating Relay Station (RS) capability in a communication system, comprising the steps of:
configuring a first message including first relay capability information indicating if a node supports an RS capability and sending the first message to an upper-layer RS by the node;
forwarding the first message to a Base Station (BS) by the upper-layer RS;
determining whether to select the node as an RS, upon receipt of the first message, configuring a second message including second relay capability information indicating if the node is selected as the RS, and sending the second message to the upper-layer RS;
forwarding the second message to the node by the upper-layer RS; and
receiving by the node the second message and operating by the node as the RS or as a general node according to the second relay capability information of the second message.

43. The method of claim 42, further comprising acquiring system synchronization and performing an initial ranging procedure with the upper-layer RS by the node, before the first message configuration step.

44. The method of claim 42, further comprising sending an indicate message including the second relay capability information to the upper-layer RS by the BS, after the second message sending step.

45. The method of claim 42, wherein the determination step comprises determining whether to select the node as the RS according to at least one of the purposes of expanding the coverage of the BS and increasing system capacity.

46. The method of claim 42, wherein the RS is at least one of an infrastructure RS installed and managed by the BS, a client RS as which a Mobile Station (MS) serves by supporting RS function, a fixed RS, a nomadic RS, and a mobile RS.

47. The method of claim 42, wherein the first message is a request message for setting up a connection to the BS via the upper-layer RS.

48. The method of claim 47, wherein the second message is a response message for the request message.

49. The method of claim 44, wherein the indicate message includes parameters required for communications between the node and the upper-layer RS.

50. An apparatus for negotiating Relay Station (RS) capability in a communication system, comprising:
a node for configuring a first message including first relay capability information indicating if the node supports an RS capability, sending the first message to an upper-layer RS, receiving from the upper-layer RS a second message including second relay capability information indicating if the node is selected as an RS, and operating as the RS or a general node according to the second relay capability information;
the upper-layer RS for receiving the first message from the node, forwarding the first message to a Base Station (BS), receiving the second message from the BS, forwarding the second message to the node, receiving an indicate message from the BS, and acquiring the second relay capability information from the indicate message; and
the BS for determining whether to select the node as the RS, upon receipt of the first message from the upper-layer RS, configuring the second message including the second relay capability information according to the determination, sending the second message to the upper-layer RS, and sending the indicate message including the second relay capability information to the upper-layer RS.

51. The apparatus of claim 50, wherein the BS determines whether to select the node as the RS according to at least one of the purposes of expanding the coverage of the BS and increasing system capacity.

52. The apparatus of claim 50, wherein the RS is at least one of an infrastructure RS installed and managed by the BS, a client RS as which a Mobile Station (MS) serves by supporting RS function, a fixed RS, a nomadic RS, and a mobile RS.

53. The apparatus of claim 50, wherein the first message is a request message for setting up a connection to the BS via the upper-layer RS.

54. The apparatus of claim 53, wherein the second message is a response message for the request message.

55. The apparatus of claim 50, wherein the indicate message includes parameters required for communications between the node and the upper-layer RS.

56. A method of negotiating Relay Station (RS) capability in an upper-layer RS in a communication system, comprising the steps of:
receiving from a node a first message including first relay capability information indicating if the node supports an RS capability and forwarding the first message to a Base Station (BS); and
receiving from the BS a second message including second relay capability information indicating if the node is selected as the RS and forwarding the second message to the node.

57. The method of claim 56, further comprising receiving an indicate message including the second relay capability information from the BS and acquiring the second relay capability information from the indicate message.

58. A method of negotiating Relay Station (RS) capability in a Base Station (BS) in a communication system, comprising the steps of:
receiving from an upper-layer RS a first message including first relay capability information indicating if a node supports an RS capability, determining whether to select the node as an RS, configuring a second message including second relay capability information indicating if the node is selected as the RS, and sending the second message to the upper-layer RS; and
sending an indicate message including the second relay capability information to the upper-layer RS.
